(19) United States
(12) Patent Application Publication
(10) Pub. No.: US 2016/0001227 A1
(43) Pub. Date: Jan. 7, 2016

(54) PROCESS FOR TREATING POLLUTANTS PRESENT IN EXHAUST GASES FROM AN INTERNAL COMBUSTION ENGINE, IN PARTICULAR FOR A MOTOR VEHICLE

(71) Applicant: IFP ENERGIES NOUVELLES, Rueil-Malmaison Cedex (FR)

(72) Inventors: Stéphane RAUX, Orlienas (FR); Arnaud FROBERT, Irigny (FR)

(21) Appl. No.: 14/769,207

(22) PCT Filed: Feb. 14, 2014
(86) PCT No.: PCT/FR2014/050310

§ 371 Date: Aug. 20, 2015

(30) Foreign Application Priority Data
Feb. 21, 2013 (FR) 13/51471

(51) Int. Cl. B01D 53/94; F01N 3/20

(52) U.S. Cl. CPC B01D 53/9418; B01D 53/9495; F01N 3/208; B01D 2251/2062

(57) ABSTRACT

The present invention is a process for treating pollutants present in exhaust gases moving in an exhaust line (22) and originating from the combustion in at least one cylinder (12) of an internal combustion engine (10), which is, in particular, a motor vehicle. The line comprises at least one selective catalytic reduction catalyst (30) for the treatment of the nitrogen oxides (NOx) present in these gases and at least one injector (28) of a reducing agent.

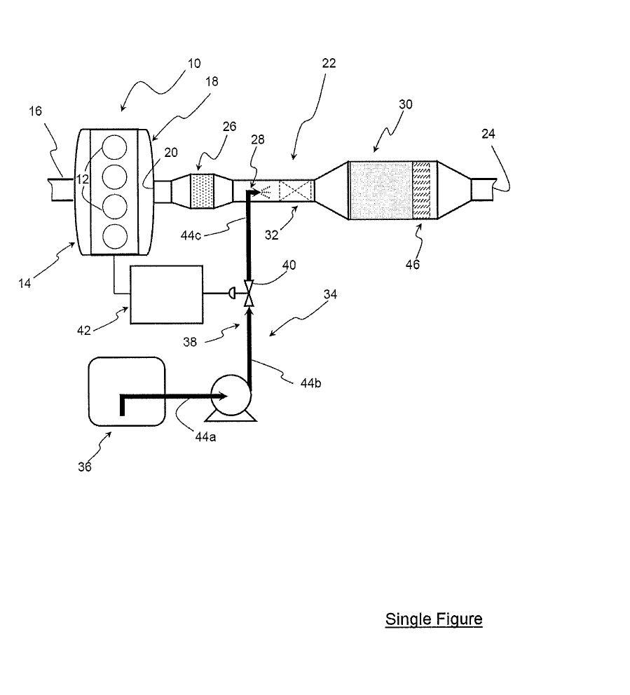

According to the invention, the process forms ammonium nitrate in the catalyst (30), and decomposes the ammonium nitrate by contributing external energy for exhaust gas temperatures of less than approximately 200° C. and a hydrocarbon is used to increase the sensitivity of the ammonium nitrate, so as to obtain a highly exothermic decomposition of this nitrate.

### CROSS REFERENCE TO RELATED APPLICATION

Reference is made to French Patent Application No. 13/51471 and PCT Patent Application No. PCT/FR2014/050310 which applications are incorporated herein by reference in their entirety.

### BACKGROUND OF THE INVENTION

1. Field of the Invention

The present invention relates to a process for treating pollutants present in exhaust gases from an internal combustion engines.

2. Description of the Prior Art

The pollutants present in the exhaust gases from an engine which result from the combustion of a carburetted mixture are mainly nonincinerated hydrocarbons (HCs), carbon monoxide (CO) and nitrogen oxides (NO and NO₂), more commonly called NOx compounds.

These NOx compounds are combustion products which are formed under conditions of high temperatures and of high oxygen contents. These conditions are encountered during all the combustion processes which take place in a lean mixture, generally by direct injection, with or without spark ignition, this being the case without the fuel used, petrol, diesel, gas, and the like.

In order to observe environmental standards relating to internal combustion engines and to respond to the increasing strictness of these standards, it is necessary to treat these pollutants before discharging the exhaust gases into the atmosphere. In particular, it is important to be able to treat the NOx compounds, which have a major impact not only on the environment but also on human health.

As is generally known, devices for the treatment of these pollutants are installed in the exhaust lines of vehicle engines. Thus, HCs and CO are treated by passing these exhaust gases through an oxidation catalyst, by virtue of which the HCs and the CO are oxidized.

In order to be able to fully treat NOx compounds, the exhaust gases pass through another catalyst, referred to as SCR (Selective Catalytic Reduction) catalyst, which makes it possible to selectively reduce the NOx compounds, ideally to nitrogen, by virtue of the action of a reducing agent. This agent can be ammonia or a compound which generates ammonia by decomposition, such as urea, a hydrocarbon or hydrogen, which is generally injected upstream of the SCR catalyst. This reducing agent is mixed with the exhaust gases and then reacts with the NOx compounds of the exhaust gases in the SCR catalyst according to several possible chemical reactions.

As is mentioned in particular in EP 0 758 714, such a device comprises an exhaust line for the gases originating from an internal combustion engine in which are placed the oxidation catalyst and means for injecting the reducing agent and the SCR catalyst.

The problem posed with such an installation lies in the fact that the SCR catalyst is only fully operational when it has reached a temperature generally of greater than approximately 200° C.

It is for this reason that two routes for movement in the exhaust gases are provided, as is better described in the abovementioned document, in which one route comprises the three-way catalyst and the SCR catalyst and another movement route ends directly at the inlet of the three-way catalyst.

This installation, apart from the fact that it is complicated to prepare and bulky with two movement routes, requires valve-regulation means in combination with control strategies for regulating the movement of the exhaust gases in one or the other route.

Furthermore, when the route comprising the SCR catalyst is fed with the exhaust gases, very hot exhaust gases pass through this catalyst and cause a thermal shock to it. Such a thermal shock can damage it, in particular when this shock is repetitive and more particularly when the SCR catalyst is at ambient temperature.

### SUMMARY OF THE INVENTION

The present invention overcomes the abovementioned disadvantages by virtue of a process which makes it possible to accelerate the rise in temperature of the SCR catalyst with a simple design and reduced cost.

To this end, the present invention relates to a process for treating pollutants present in exhaust gases moving in an exhaust line and originating from the combustion in at least one cylinder of an internal combustion engine, in particular for a motor vehicle with the line comprising at least one selective catalytic reduction catalyst for the treatment of the nitrogen oxides present in these gases and at least one means (mechanism) for injection of a reducing agent, characterized in that the process includes:
forming ammonium nitrate in the catalyst; and
decomposing the ammonium nitrate by contributing external energy for exhaust gas temperatures of less than approximately 200° C. with a hydrocarbon being used to increase the sensitivity of the ammonium nitrate to obtain a highly exothermic decomposition of the nitrate.

The process forms ammonium nitrate by bringing together the ammonia resulting from the reducing agent introduced at the exhaust and NO₂ resulting from the combustion.

The process can place at least one catalyst upstream of the SCR catalyst.

In the configuration where the catalyst is an oxidation catalyst, the process can form ammonium nitrate by bringing together the ammonia resulting from the reducing agent introduced at the exhaust and NO₂ resulting from the oxidation, over the oxidation catalyst, of a portion of the NO resulting from the combustion.

The process can form the ammonium nitrate when the NO₂/NOx molar ratio of the exhaust gases is greater than approximately 0.5.

The process can estimate the amount of ammonium nitrate in the SCR catalyst by an observer incorporated in the software for controlling the engine.

The process can use a nonincinerated hydrocarbon originating from the combustion in the at least one cylinder.

The process can inject a hydrocarbon into the exhaust line upstream of the SCR catalyst.

The process can use a reducing agent comprising ammonia.

The process can use a precursor reducing agent comprising ammonia.

The process can place at least one catalyst or a particle filter or another SCR catalyst downstream of the first SCR catalyst.

The other characteristics and advantages of the invention will now become apparent from reading the description which follows, given solely by way of illustration and without implied limitation, and to which is appended the single FIGURE which is a diagram showing a device for the treatment of exhaust gases from an internal combustion engine.

With reference to the FIGURE, the internal combustion engine 10, in particular of diesel type, comprises at least one cylinder 12, an intake manifold 14 with its external air intake 16 and an exhaust manifold 18 which makes it possible to collect the exhaust gases resulting from the combustion of a carburetted mixture in the cylinders in order to direct them to the inlet 20 of an exhaust line 22.

In the FIGURE, the exhaust line carries, in the direction of movement of the exhaust gases proceeding from the inlet 20 of this line towards its outlet 24, at least one catalyst, in particular an oxidation catalyst 26, placed as close as possible to the exhaust gas inlet 20, followed by an injector of a reducing agent 28 placed opposite an SCR catalyst 30. For this catalyst, two main types of composition can be used, either catalysts based on mixed oxides, such as V₂O₅—WO₃/TiO₂, which are widely used for heavy trucks, or catalysts with structures of aluminosilicate type, known as zeolites, exchanged with metal ions (conventionally iron or copper), which are more suitable for light applications.

This line can also carry a temperature sensor (not represented) for the exhaust gases which is housed close to the inlet of the SCR catalyst. This sensor makes it possible, in combination with the computer which any internal combustion engine normally comprises, to know the temperature of the exhaust gases which enter this catalyst. This temperature can also be determined using an exhaust thermal model.

Advantageously, a mixing region or mixer 32 can be provided between the injector 28 and the SCR catalyst 30 in order to carry out virtually uniform mixing between the reducing agent and the exhaust gases.

The injector 28 forms part of a line 34 for feeding the reducing agent which comprises a tank 36 containing the agent and a metering pump 38 with its solenoid valve 40 connected to a control circuit 42. The tank, the metering pump with its solenoid valve and the injector are connected to one another by pipes for circulation of reducing agent, respectively 44a, 44b and 44c.

Without departing from the scope of the invention, the exhaust line described above may not comprise oxidation catalysts upstream of the SCR catalyst and/or may comprise one or more catalysts 46 or a particle filter (PF) or another SCR catalyst, downstream of this SCR catalyst, as represented in dotted lines in the FIGURE.

The operation of the device will now be explained in connection with a reducing agent comprising ammonia and/or a precursor reducing agent comprising ammonia which is introduced into the exhaust gases. This agent can be introduced therein either directly in the gas form, in the case where it is stored in the form of solid complexes, such as those sold under the name of “ASDS System” by Amminex or under the name of “Solid SCR System” by Tenneco, or indirectly by injection of a liquid precursor, for example urea in aqueous solution, such as that better known under the “AdBlue” terminology in European countries or under the abbreviation DEF (Diesel Exhaust Fluid) in the United States.

In the example described below, the reducing agent used is urea in aqueous solution, which is stored in the tank 36.

Under the optimum operating conditions of the SCR catalyst, that is to say when the temperature of the exhaust gases measured by the temperature sensor is greater than approximately 200° C., the urea in aqueous solution is withdrawn from the tank 36 by the metering pump 38 in order to be injected into the exhaust line by the injector 28.

This urea in aqueous solution, the amount of which is controlled by the control circuit 42 acting on the solenoid valve 40 as a function of the operating parameters of the engine 10, is mixed with the exhaust gases in the mixing region 32. Under the effect of the temperature of the gases, the water which the urea in aqueous solution contains is rapidly evaporated and then each urea molecule is decomposed according to two stages to give ammonia molecules:

(NH₂)₂CO==>NH₃+HNCO (1)

HNCO+H₂O==>NH₃+CO₂ (2)

Thus, as a function of the NO and NO₂ composition of the NOx compounds of exhaust gases, of the temperature and of the flow rate of these gases, three main reactions resulting from the selective catalytic reduction by ammonia can take place.

The first reaction, referred to as “Fast SCR”, is:

2 NO+2 NO₂+4 NH₃→4 N₂+6 H₂O (3)

The “standard” reaction corresponds to:

4 NO+4 NH₃+O₂→4 N₂+6 H₂O (4)

Finally, the reaction called “NO₂ SCR” corresponds to:

6 NO₂+8 NH₃→7 N₂+12 H₂O (5)

With reference to the FIGURE, the reaction (1) mainly takes place in the mixing region 32, while the other reactions (2) and (3) or (4) or (5) take place in contact with the SCR catalyst.

In a campaign of tests carried out by the applicant, it was brought up to date that, for exhaust gas temperatures of less than approximately 200° C. and when NO₂ is predominantly present, a portion of the NH₃ released by the reactions (1) and (2) and the NO₂ do not react to form N₂, as desired by the SCR reaction (reaction (3), (4) or (5)), but combine to form ammonium nitrate (NH₄NO₃).

This generally takes place when the engine is used with low exhaust gas temperatures, such as idling, low charges or lifting the foot from the accelerator. For reasons of simplicity, the continuation of the description will mention only the generic term “low use” in order to combine the three operating cases above.

This ammonium nitrate is subsequently deposited in the solid form in the catalyst.

The ammonium nitrate present in the SCR catalyst can be decomposed, weakly exothermically, from approximately 185° C. in the form of H₂O, of N₂O, indeed even of ammonia and of NO₂, or, highly exothermically, at a temperature of the gases of approximately 300° C., in the form of H₂O, O₂ and N₂.

During this campaign of tests, the applicant was able to bring out that the ammonium nitrate has the distinguishing feature of reacting very exothermically at temperatures far below 300° C. with a low external energy contribution if the sensitivity of the ammonium nitrate is increased, that is to say if the minimum activation energy necessary for a self-sustaining decomposition of the substance is lowered. This is the case if the ammonium nitrate comes into contact with, inter alia, hydrocarbons at low concentration.

For stoichiometric proportions, for example, the reaction is written:

3n NH₄NO₃+(—CH₂—)n→3n N₂+7n H₂O+n CO₂ (6)

The hydrocarbons may also have partially reacted over the oxidation catalyst with a formation of nitromethane, which, subsequently, will come into contact with the ammonium nitrate to decompose it according to

3 NH₄NO₃+2 CH₃NO₂→2 CO₂+9 H₂O+4 N₂ (7)

It is thus advisable to have available a controlled amount of ammonium nitrate deposited on the SCR catalyst so as to generate the desired exotherm.

For this, as soon as the favorable temperature conditions are encountered, typically below 200° C., it is advisable to bring together either the ammonia from the injection of reducing agents at the exhaust or the ammonia already present, by adsorption, on the catalyst and NO₂ resulting from the combustion and/or from the oxidation of a portion of the NO resulting from the combustion over the oxidation catalyst, when the latter is present.

This is in particular the case under the conditions known as “low use” of the engine where the injection of a reducing agent comprising ammonia or ammonia precursor may be desired.

The amount of stored ammonium nitrate can be estimated by an observer incorporated in the engine control software, calling on information, inter alia, of temperatures at various points in the exhaust line (gas temperature upstream of the SCR catalyst, estimation or measurement of the temperature of the SCR catalyst), exhaust gas flow rate, history of the amount of reducing agent injected, estimated or measured concentration of NO and NO₂, and estimated amount of ammonia adsorbed on the SCR catalyst.

According to the state of this observer, it may be desired to generate ammonium nitrate according to the process described above.

In view of the low temperature of exhaust gases, the oxidation catalyst 26 placed upstream of the SCR catalyst is not lit off or partially active, and allows the molecules of nonincinerated hydrocarbons (HCs) resulting from the combustion to pass. These HCs sufficiently sensitize the nitrate so as to decompose it highly exothermically by moderate contribution of thermal energy present in the gases resulting from the combustion in the engine.

By virtue of this, the exothermic decomposition of the ammonium nitrate is used to accelerate the rise in temperature of the SCR catalyst or to maintain this catalyst at temperature so as to render more precautiously operational the depollution of the NOx compounds by the SCR catalysis.

It may be noted that the exothermicity of this decomposition can also be used to raise or maintain the temperature, by transportation of heat, of the components for treatment of the gases located downstream of this SCR catalyst.

In order for the ammonium nitrate to be able to be formed and deposited on the SCR catalyst, in addition to the ammonia stored on the SCR catalyst or resulting from the decomposition of the reducing agent injected at the exhaust, the NO₂ and the NOx compounds of the exhaust gases have to be present at the inlet of the SCR catalyst 30 with, preferably, an NO₂/NOx molar ratio of greater than 0.5.

This ratio can be mainly ensured by the result of the combustion in the cylinders 12 in the case where there is no oxidation catalyst upstream of the SCR catalyst 30 or for temperature conditions where the oxidation catalyst is not or not very active. It should be noted that, in the case where the oxidation catalyst is active, it makes it possible to oxidize a portion of NO to give NO₂.

Entities in a position to sensitize the ammonium nitrate so as to decompose it highly exothermically can be contributed in several ways, when the oxidation catalyst is not active or weakly active, such as, for example:
Nonincinerated hydrocarbons resulting from the combustion in the cylinders 12 of the engine;
Hydrocarbons originating from the injection of hydrocarbons into the cylinders, such as a post injection;
Hydrocarbons injected into the exhaust line upstream of the SCR catalyst.

The energy required to initiate the highly exothermic decomposition of the ammonium nitrate can be contributed by the heat of the exhaust gases or by any other system, such as a heating electrical resistance.

Furthermore, it may be pointed out that the ammonium nitrate thus formed can be used:
after the engine has been halted, in order to light off the SCR catalyst (and the catalysts optionally located downstream of it) when next starting up according to the principle described above,
in the case of maintenance of the operation of the engine, if the catalysts are lit down, in order to again light off the SCR catalyst (and the catalysts optionally located downstream of it) according to the same principle described or, if the catalysts are not lit down, to provide the reactions for reduction of the NOx compounds in which it is conventionally involved.

1.-11. (canceled)

12. A process for treating pollutants present in exhaust gases moving in an exhaust line and originating from combustion in at least one cylinder of an internal combustion engine, the line comprising at least one selective catalytic reduction SCR catalyst for treatment of nitrogen oxides present in the gases and at least one injection of a reducing agent the process comprising:
forming ammonium nitrate in the catalyst; and
decomposing the ammonium nitrate by contributing external energy for exhaust gas temperatures of less than approximately 200° C. and a hydrocarbon for increasing sensitivity of the ammonium nitrate to obtain an exothermic decomposition of the nitrate.

13. A process according to claim 12, forming ammonium nitrate by bringing together ammonia resulting from reducing agent introduced in the exhaust gases and NO₂ resulting from the combustion.

14. A process according to claim 12, comprising placing at least one catalyst upstream of the SCR catalyst.

15. A process according to claim 14, wherein the catalyst is an oxidation catalyst, which forms ammonium nitrate by bringing together ammonia resulting from the reducing agent introduced in the exhaust and NO₂ resulting from oxidation, over oxidation catalyst, of a portion of NO resulting from the combustion.

16. A process according to claim 12, comprising forming the ammonium nitrate when a NO₂/NOx molar ratio of the exhaust gases is greater than approximately 0.5.

17. A process according to claim 13, comprising forming the ammonium nitrate when a NO₂/NOx molar ratio of the exhaust gases is greater than approximately 0.5.

18. A process according to claim 14, comprising forming the ammonium nitrate when a NO₂/NOx molar ratio of the exhaust gases is greater than approximately 0.5.

19. A process according to claim 15, comprising forming the ammonium nitrate when a NO₂/NOx molar ratio of the exhaust gases is greater than approximately 0.5.

20. A process according to claim 12, comprising estimating an amount of ammonium nitrate in the SCR catalyst by an observer incorporated in software for controlling the engine.

21. A process according to claim 13, comprising estimating an amount of ammonium nitrate in the SCR catalyst by an observer incorporated in software for controlling the engine.

22. A process according to claim 14, comprising estimating an amount of ammonium nitrate in the SCR catalyst by an observer incorporated in software for controlling the engine.

23. A process according to claim 15, comprising estimating an amount of ammonium nitrate in the SCR catalyst by an observer incorporated in software for controlling the engine.

24. A process according to claim 16, comprising estimating an amount of ammonium nitrate in the SCR catalyst by an observer incorporated in software for controlling the engine.

25. A process according to claim 17, comprising estimating an amount of ammonium nitrate in the SCR catalyst by an observer incorporated in software for controlling the engine.

26. A process according to claim 18, comprising estimating an amount of ammonium nitrate in the SCR catalyst by an observer incorporated in software for controlling the engine.

27. A process according to claim 19, comprising estimating an amount of ammonium nitrate in the SCR catalyst by an observer incorporated in software for controlling the engine.

28. A process according to claim 12, comprising using a nonincinerated hydrocarbon originating from combustion in the at least one cylinder.

29. A process according to claim 12, comprising injecting a hydrocarbon into the exhaust line upstream from the SCR catalyst.

30. A process according to claim 12, comprising using a reducing agent comprising ammonia.

31. A process according to claim 12, comprising using a precursor reducing agent comprising ammonia.

32. A process according to claim 12, comprising placing at least one of a catalyst, a particle filter or another SCR catalyst downstream of the at least one selective catalytic SCR catalyst.
